(19) United States
(12) Patent Application Publication
(10) Pub. No.: US 2006/0080114 A1
(43) Pub. Date: Apr. 13, 2006

(54) Method and system for providing real estate search information

(75) Inventors: George D. Bakes, New Canaan, CT (US); Steven A. Matsis, Newtown, CT (US); David L. Wells, Guilford, CT (US)

Correspondence Address: Lipsitz & McAllister, LLC, 755 MAIN STREET, MONROE, CT, 06468, US

(73) Assignee: Real Soft Commercial Connection, LLC, Stamford, CT (US)

(21) Appl. No.: 10/961,123

(22) Filed: Oct. 7, 2004

(51) Int. Cl. G06Q 99/00

(52) U.S. Cl. 705/1

(57) ABSTRACT

A computerized system is provided for managing commercial real estate properties comprising a core database including a property listing database and a member listing database. A data module is coupled to the core database. The data module provides commercial real estate data to the core database. At least one working module is in operative communication with the core database. A system user is permitted to store criteria for enabling the system to locate properties of interest. New properties meeting the criteria are automatically presented to the system user.

### BACKGROUND

The present invention relates to an interactive computer-implemented method and system for routinely searching a real estate property database, and particularly to the use of a set of predetermined preferences to determine the importance of the search results.

In the commercial real estate market, users and real estate investors will seek financial data on a property prior to even physically seeing it. Extensive information regarding rents, vacancy rates, and similar properties is often the norm.

Real estate agents from around the United States employ various forms of a property listing system often referred to as the Multiple Listing Service (MLS). In addition, any type of market data generated by the MLS is local in nature and cannot be easily translated into state, regional, or national trends. In most instances, the current listing system provides limited opportunity for an agent to handle the sale of a client's property and the purchase of a new property for the same client unless the move is local.

The majority of real estate advertising today is through local newspapers and trade publications. These advertisements are limited in space. If changes in price, terms, or availability occur, the ability to change property information is restricted by production deadlines and the like. In short, the traditional advertising mediums used for real estate advertising are usually non-measurable, limited in choice, fairly expensive and often non-exclusive in nature.

To facilitate transactions, industry participants must have extensive, accurate, and current information. Members of the commercial real estate and related business community require daily access to current data, such as rental rates, vacancy rates, tenant movements, supply, new construction, geographical demographics, and other important market developments to carry out their businesses effectively. Such data collection is time-consuming. Real estate professionals spend a large portion of their workday collecting and analyzing information on the real estate market.

The parties involved in the commercial real estate and the related business community that require extensive information include: sales and leasing brokers; property owners; property management firms; design and construction firms; real estate developers; real estate investment trusts; investment banks; commercial banks; investors and asset managers; government agencies; mortgage-backed security issuers; appraisers; media; tenant vendors; building services vendors; communications providers; insurance companies; and institutional advisors.

These people need current data in a location that can be easily attained. In addition, these people need to be able to quickly disseminate the data to clients, such as buyers, tenants, vendors, landlords, sellers, owners and the like.

What is needed in the art is a system for managing commercial real estate property having a capacity to search real estate property databases pertinent to user-defined criteria and provide property listings in a format that is accessible.

### SUMMARY

The present disclosure is directed toward a computerized system for managing commercial real estate properties. The computerized system comprises a core database including a property listing database and a member listing database. A data module is coupled to the core database, such that the data module provides commercial real estate information to the core database. At least one working module is in operative communication with the core database.

In another embodiment, a contact manager is coupled to the core database. The contact manager includes a listing of contact information.

In another embodiment, the data module comprises one of a system users module, a mapping source module, a demographics module and a news providers module.

In another embodiment, the working module includes a first working module in operative communication with the core database. The first working module includes at least one of a preview property module, a search property module, an add a listing module, a management tools module, a resources module and a press module. The first working module is configured to operate using a web based operating structure. A second working module is configured to operate using a local graphical user interface-based operating structure. The second working module includes a management tools module comprising an appointments module, a property watch module, a prospect tool module and a listing tool module. The working module is configured for a system user to access property specific data responsive to system user defined criteria upon entry into the working module. The working module can comprise a plurality of working modules.

The present disclosure is also directed towards a computerized method for managing commercial real estate properties. The method comprises referencing a core database that includes a property listing database and a member listing database. The method includes executing commands through at least one working module in operative communication with the core database, such that the commands enable a system user to access property specific data responsive to system user defined criteria. The method includes reading data files from a data source module. The data source module includes a system user module, a mapping source module and a demographic module. The data source module contains the property specific data in the data files.

In another embodiment, at least one working module includes at least one of a webpage tool module and a local graphical user interface (GUI) module configured to execute at least one of a preview property module, a listing module, a search property module, a contacts module, a resources module, a management tools module, a press module and a reports module.

In another embodiment, the system provides a contact manager module including a database of contact entries imported from the system user. The property listing database receives the property-specific data from the system user, cross references a location of a property related with the property-specific data with the mapping source and the demographic database, and compiles a complete property listing. The member listing database provides user information and user preferences. The management tools module comprises a property watch module, a contacts module, listings module and an appointments module. The appointments module lists system user entered events and tracks the system user entered events responsive to system user entry. The prospect tool module includes a property watch module adapted to filter property information responsive to predetermined system user preferences based on a type of property, saves the predetermined system user preferences, recognizes a plurality of system user preferences for access, and the prospect tool module includes a buyers and tenants module comprising a list of contacts recorded by a user. The listing tool module includes a list of properties having associated attributes a user has loaded into the tools module, the list of properties viewable based on a type of property, a list of prospects, activity related to the listing, a listing and rates, an expiration date related with a property from the list of properties, a list of commission rates, special terms related to the listing, attached files (e.g., letters, spreadsheets and marketing materials) that provide a history, photographs, maps and demographics related to the listing.

The present disclosure is also directed towards a system for providing real estate services to system users. The system comprises an intermediary, at least one computer having access to an interactive computer network, a searchable database consisting of multiple modules with associated real estate information maintained and monitored by the intermediary; and a server provided by the intermediary in communication with the computer and the database. System users can access the searchable database with associated working modules via the interactive communication network through the computer. System users can select a property listing from the database. System users can select sections within the working modules to obtain predetermined preferences about the property. The working modules generate a property listing consistent with the predetermined preferences about the property. The system comprises a web browser running at the computer, a web server at the intermediary, and at least one web page associated with each searchable database. In another embodiment, the system users are members of an organization. The members include a commercial real estate broker and the organization includes a brokerage firm. The working modules generate a property listing consistent with the predetermined preferences about the property upon entry into the system.

### BRIEF DESCRIPTION OF THE DRAWINGS

Referring now to the figures, wherein like elements are numbered alike:

FIG. 1 is a block diagram of an exemplary system for managing commercial real estate properties;

FIG. 2 is a block diagram of an exemplary tools module;

FIG. 3 is a block diagram showing networked components implementing a system in accordance with the invention.

FIG. 4 is a screen-shot showing an exemplary listing tool module in accordance with the invention.

FIG. 5 is a screen-shot showing an exemplary prospect tool module in accordance with the invention.

FIG. 6 is a screen-shot showing an exemplary appointments module in accordance with the invention.

### DETAILED DESCRIPTION

Persons of ordinary skill in the art will realize that the following description of the present disclosure is illustrative only and not in any way limiting. Other embodiments of the invention will readily suggest themselves to such skilled persons having the benefit of this disclosure.

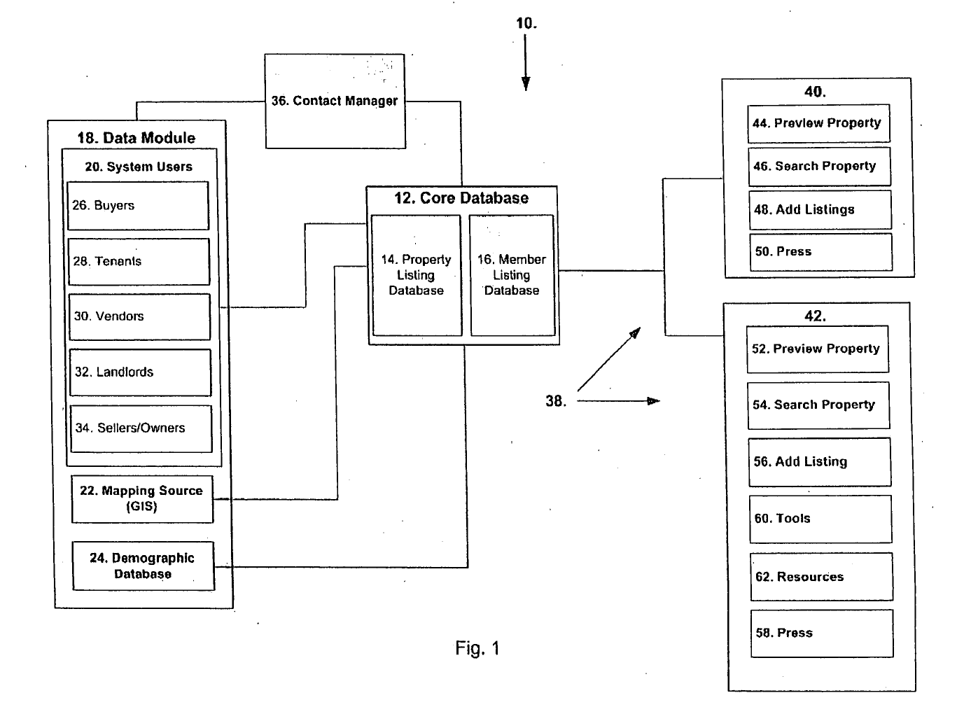

FIG. 1 is a block diagram of an exemplary commercial real estate property management system (system) 10. The system for managing commercial real estate property 10 includes a core database 12 including a property listing database 14 and a member listing database 16. The core database 12 is the master source of data for the system 10. The core database 12 can be referenced for any system activity. The core database 12 can support any action, addition, search, and the like.

The property-listing database 14 is loaded with property specific data entered by a system user (user). The property-listing database 14 is configured to provide a complete property listing. The complete property listing includes, for example, property address and location information, maps, population statistics, changes in population, trends in population, information regarding population, such as, age, gender, religious affiliation, ethnic background, income levels, and the like.

The member-listing database 16 includes the information pertinent to the users of the system 10. The user information can include contact information, occupation, title, and the like. The member-listing database 16 also includes the users preferences for the commercial real estate. The user preferences can include user-defined criteria utilized in the system 10 to display only the property listings that match the user-defined criteria. In an exemplary embodiment, the user can predefine the user preferences to include a property for sale or for lease. The user preference can include the property type and the property subtype. Property location, and property criteria can also be included in the user preferences.

A data module 18 is coupled to the core database 12. The data module 18 provides commercial real estate data to the core database 12. The data module 18 includes a system users module 20, a mapping source module 22 and a demographics database module (or demographics module) 24.

The system users module 20 includes a listing of users that have access to the system 10. The access control for the users can include a username and password for accessing the system 10. System users can be divided into main categories, such as, buyers 26, tenants 28, vendors 30, landlords 32, and sellers/owners 34. Other categories can be included. The listing of users in the system users module 20 is used to provide the data of the users for use in combination with the other system modules of the system 10.

The mapping source module 22 is configured to provide an area map based on the “passed” address (or the pertinent address). The mapping source module 22 can include a third party computer application for providing the map information. The mapping source module 22 is in operative communication with the core database 12.

The demographics database module (or demographics module) 24 includes a database of real estate specific demographic statistics organized by postal zip codes. The demographics module 24 includes a database provided by a vendor that prepares real estate specific demographic statistics. The demographic statistics can include a surveyed study of population statistics, changes in population, and trends regarding local populations. The trends can include information pertaining to population age, gender, ethnic background, income levels, and the like. In a preferred embodiment, a vendor can develop the demographic statistics. The demographics module 24 can provide, e.g., a 1, 3, 5 Mile Report. The 1, 3, 5 Mile Report includes a plot of the pertinent address at the center of a map. A perimeter around the pertinent address is defined at a distance of one mile from the center. Another perimeter is defined at a distance of three miles from the pertinent address. A perimeter is also defined at a distance of five miles from the pertinent address. A report is created containing all demographic data within the defined perimeters at the one, three and five mile radii.

A contact manager module (or contact manager) 36 is coupled to the core database 12 and the data module 18. The contact manager 36 is a database of contact entries. The contact entries include information about people (i.e., contacts) of interest to the system user. The database is created through system user entries and by importation from other sources, such as another information software utilized by the system user (e.g., Microsoft Outlook® software). The contact entries can include information such as first name, last name, company name, occupational title, telephone number, facsimile number, mobile telephone number, state, county, city, street, zip code, email address, website address, and the like. The contact manager 36 can include a section for notes and miscellaneous entries. The contact manager 36 is connected to both the core database 12 with the data module 18.

At least one working module 38 including at least one of a first working module (or webpage tool) 40 and a second working module (or desktop tool) 42 is coupled to the core database 12. The working module 38 is configured to access the core database 12 and any connected modules for the production of pertinent information for the system user. The first working module 40 is configured as a web-based system configured to provide web-based access to the system 10 from any location having web access capacity. The first working module 40 includes features available to the system user. The features can include a preview property feature 44, a search property feature 46, an add listings feature 48 and a press feature 50.

The preview property feature 44 includes access to property specific data, mapping information and the 1, 3, 5, Mile Report for the system user. The preview property feature 44 is configured to print, email, and display the property specific data, mapping information and the 1, 3, 5, Mile Report. In an exemplary embodiment, the preview property feature 44 can be utilized through the system 10 to graphically represent a property listing in order to print, email, or display the information to clients. The preview property feature 44 activates the system 10 through the core database 12 to locate a specific property listing in the property-listing database 14. An identification number can be used to identify individual property listings in the property-listing database 14. The property specific data can be organized in a predefined one-page view for display. The preview property feature 44 activates the core database 12 to query the mapping source module 22 and the demographics module 24 to obtain mapping information, and a 1, 3, 5 Mile Report for display on consecutive pages.

The search property feature 46 is configured to facilitate for the system user the creation of specific property searches based on specific property criteria. The specific property criteria can be responsive to the needs of the system user. The system 10 matches the criteria created in the search property feature 46 with the property-listing database 14. The matching listings found in the property-listing database 14 are populated in a search results window of the search property feature 46.

The add listings feature 48 is configured to enable the system user to create a listing that can be viewed by other system users. The add listings feature 48 receives input from the system user indicating criteria regarding the property. The criteria can include whether the property is available for sale or for lease, the property type, the property subtype, as well as a variety of fields of property specific data.

Property specific data includes data entered into the property-listing database 14 that is useful in describing a particular property. Depending on the property type and the sale type, different and unique information can be required in order to complete a listing. The property specific data can include, but is not limited to, an address of the property, financial information, photographs, property type, sale type, as well as, for sale, for lease, property category, actual gross income from the property, projected gross income from the property, total expenses, cap rate, NOI, status of the property, list price, building size in square feet, price per square foot, occupancy, lot size, parking space capacity, zoning pertinent to the property, real estate taxes, number of stories, year built, construction type, loading dock access, ceiling heights, floor load capacity, floor type, distances to nearest highway, overhead door access, electrical specifications, lease terms, elevators and elevator types, trailer access, water/sewer hookup, waste system specifications, heating system specifications, refrigeration capacity, fire protection systems, marketing package availability, days on market data, company contact information, and a customized entry area for the system users to indicate other description data, location data, directions, and remarks.

The property type of classification for commercial real estate properties includes subcategories specific to each type. An exemplary listing of property type includes: office type including subcategories of General office property, Condominium, R & D, Medical, Office/Showroom, Flex, Office Park, Neighborhood, and the like. Another property type includes retail property having subcategories of Strip Center, Anchored Center, Power Center, Discount Center, Pad, Restaurant/Food, Freestanding, Downtown/Street, Mixed Use, Automotive, and the like. Industrial property makes up another classification having subcategories of Manufacturing, Warehouse, Flex, Office/Showroom/, Food Distribution, Industrial Park, Self Storage, and Trucking/Shipping. Apartments make up another classification having subcategories of Low Rise, High Rise, Multi-Family, Assisted Living, Senior Complex, and the like. Land makes up another classification having subcategories of Office Building, Retail Center, Industrial, Pad, Self Storage, Residential, Recreational, and the like. Restaurants make up another classification having subcategories of Full Service, Diner, Nightclub/Bar, Pizza, Fast Food, Roadside Stand, Donut/Bakery, and the like. Hospitality (Hotels) makes up a classification with subcategories such as, Hotel, Budget/Limited Service, Motel, Inns, Resorts, Conference Centers, Health/Fitness, and the like.

The press feature 50 is configured to allow a system user to access accurate and up-to-date news information without exiting the system 10. The press feature 50 includes a compilation of online news feeds, classified advertisements, wants and needs, traffic camera images, stock quotes, weather reports and local broker announcements. The press feature 50 is a convenient feature allowing the system user to remain in the system 10 and gain news information in the absence of navigating out of the system 10 to alternative web sites.

Also illustrated in FIG. 1, the second working module 42 is coupled to the core database 12. The second working module 42 is configured as a desk-top system configured to provide a media loadable on a computer, such as a CD-ROM containing the system 10 loaded onto an office personal computer. The second working module 42 includes features available to the system user similar to the first working system 40. The features can include a preview property feature 52, a search property feature 54, an add listings feature 56 and a press feature 58, as well as the additional features of a management tools feature (tools) 60 and a resources feature 62. In a preferred embodiment, the second working module 42 can operate as a windows based operating system (e.g., Microsoft Windows® software). In alternate embodiments, various operating systems are contemplated.

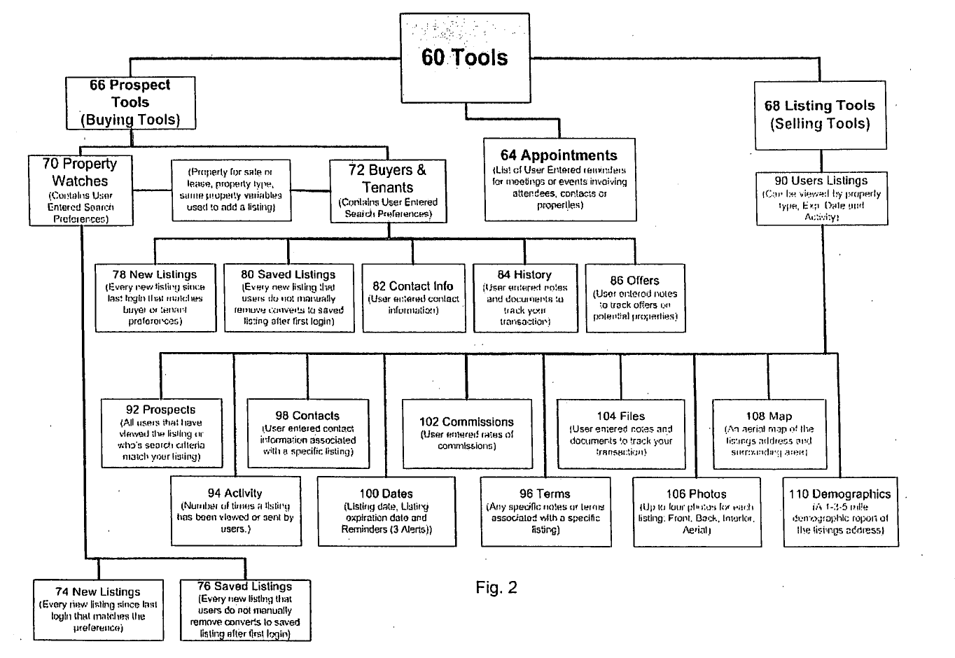

FIG. 2 is a block diagram showing the management tools (tools) feature 60 in greater detail. The tools feature 60 includes three modules that facilitate the commercial real estate property management system 10. The three modules are an appointments module 64, a prospect tool module 66, and a listing tool module 68.

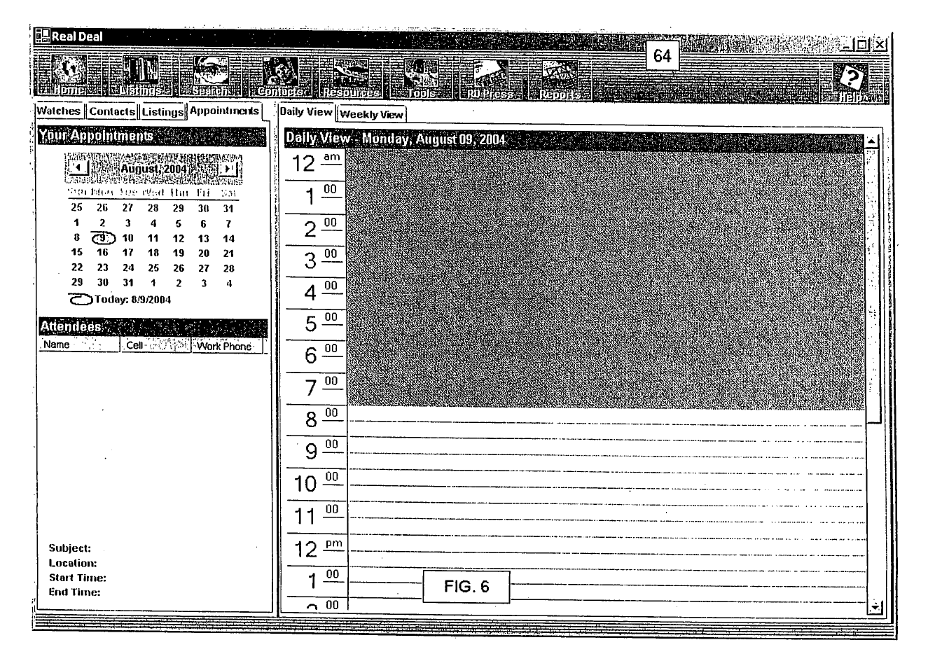

The appointments module 64 includes a list of system user events entered by the system user for the purpose of reminding the system user of the occurrence of an event. In a preferred embodiment, the appointments module includes a calendar. The calendar has the capacity to track the date, as well as track events deemed to have a priority to the system user on a given date. The appointments module 64 is configured to accept system user inputs including pertinent information about the date, events associated with a date, and an open field for entering a description associated with an event. In an exemplary embodiment, the appointment module 64 includes object buttons organized as “plus” or “add” for entering information. The appointment module 64 includes object buttons organized as “minus” for removing information from the module 64. It is contemplated that other object elements can be used along with or instead of the buttons for operating the appointments module 64. The appointments module 64 includes a menu having fields for entering a brief description of an appointment, the location of the appointment, a subject name associated with the appointment, and a start time and end time for the appointment. The appointments module 64 provides the system user with view capability of the list of appointments previously entered in the module 64. The system user can fill out the fields and “add” the information into the database for the appointments. A double click capability is included in the appointments module 64 allowing a system user to double click on the appointments list, return the view capability for the appointments fields, and the data entry window for editing or for expanded view of the information for the specific appointment from the appointment list. Reference FIG. 6 for an exemplary screen-shot of a portion of the appointments module 64.

The prospect tool module 66 includes two sections, a property watch section 70 and a buyer/tenant section 72. The system user configures the prospect tool module 66 to facilitate the purchase or leasing of properties.

The property watch section 70 includes two subsections, a new listings subsection 74 and a saved listing subsection 76. The property watch section 70 is configured to filter property data based on system user preferences. The property watch section 70 includes a search screen configured to promote searches based on the type of property desired, the subtype of property sought after and other criteria. The other criteria can include whether the property desired is for sale or for lease. The capacity to further define the property search includes a list of property characteristics specific to the property type. The property watch section 70 functions similar to the add listings feature 48 and the search property feature 54 discussed above. The system user preferences selected in the property watch section 70 can be saved, thus having to be entered once and made available for future use by the system user. The property watch section includes a drop down list of saved preferences. A system user can customize and store the search criteria for quick access in the future.

The system user preferences selected in the property watch section 70 can be saved, thus having to be entered once and made available for future use by the system user. The property watch section includes a drop down list of saved preferences. A system user can customize and store the search criteria for quick access in the future.

The new listing subsection 74 of the property watch section 70 is configured to generate a listing of property that matches the system user-defined preferences of the property watch section 70. The listing in the new listing subsection 74 is generated for every property matched to the system user-defined preferences since the most recent login into the system 10 by the system user. The new listing subsection 74 refreshes the property watch section 70 property listing automatically. If the system user does not manually remove the new listing subsection 74 additions, then the additions to the property watch section 70 list remain in the saved listing subsection 76 of the property watch section 70 subsequent to the system user logging out of the system 10.

The saved listing subsection 76 of the property watch section 70 is configured to save and contain all of the property listings that match the system user-defined preferences. The saved listing subsection 76 retains the property listings until the system user deletes the property listing. The property listings that match the system user-defined preferences remain available for review in the saved listing subsection 76.

The buyer/tenant section 72 of the prospect tool module 66 is configured to contain system user-entered preferences. The buyer/tenant section 72 contains a list of all contacts that the system user has recorded in folders within the buyer/tenant section 72. The buyer/tenant section 72 accesses several subsections for information pertaining to the contacts. The buyer/tenant section 72 subsections are a new listing subsection 78, a saved listing subsection 80, a contact information subsection 82, a history subsection 84, an offers subsection 86, and an attached files subsection 88.

The new listing subsection 78 of the buyer/tenant section 72 is similar to the new listing subsection 74 of the property watches section 70. The new listing subsection 78 of the buyer/tenant section 72 is also configured to generate a listing of properties that matches the system user-defined preferences of the buyer/tenant section 72. The listing in the new listing subsection 78 is generated for every property matched to the system user-defined preferences since the most recent login into the system 10 by the system user. The new listing subsection 78 is refreshed automatically. If the system user does not manually remove any additions to the new listing subsection 78, the new additions to the buyer/tenant section 72 list remain in the saved listing subsection 80 of the buyer/tenant section 72 subsequent to the system user logging out of the system 10.

The saved listing subsection 80 of the buyer/tenant section 72 is similar to the saved listing subsection 76 of the property watch section 70. The saved listing subsection 80 of the buyer/tenant section 72 is configured to save and contain all of the property listings that match the system user-defined preferences. The saved listing subsection 80 retains the property listings until the system user deletes the property listing. The property listings that match the system user-defined preferences remain available for review in the saved listing subsection 80.

The contact information subsection 82 of the buyer/tenant section 72 is configured to provide information for people having a real estate property relationship with the system user. The information includes a name, a title, company affiliation, address, telephone numbers, facsimile number, email address, and website address. The system user can more easily locate the information needed to communicate with the contact people by use of the contact information subsection 82.

The history subsection 84 of the buyer/tenant section 72 is configured to allow for a system user to record information pertinent to communication with a contact person. The history subsection 84 includes a lookup feature that includes fields that can be entered by the system user to document the type of communication. In an exemplary embodiment, the system user can operate a window in the history subsection 84 and indicate the mode of communication (e.g., email, telephone) and record the event. The time and date of the communication can be recorded. The history subsection 84 also allows for a brief written description of the topic of the communication in a written field. It is contemplated that other means of accessing the entry fields besides windows can be employed.

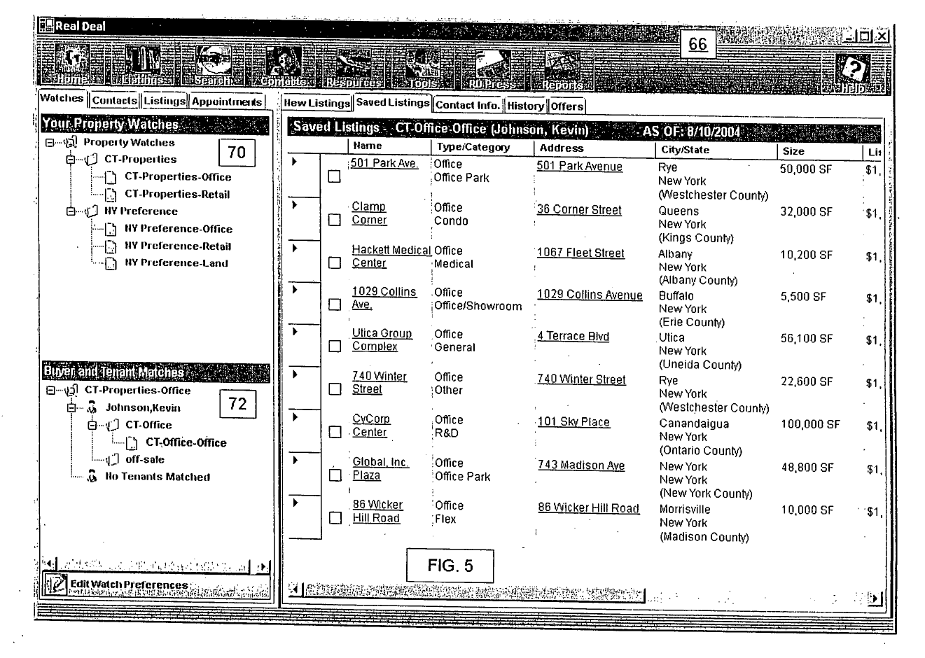

The offers subsection 86 of the buyer/tenant section 72 is configured to allow the system user to enter and record information pertinent to offers made for properties. The offers subsection 86 includes data entry fields that document the offer. The data entry field can include date of the offer, the property associated with the offer, and a brief description of the offer. Reference FIG. 5 for an exemplary screen-shot of a portion of the prospect tools module 66.

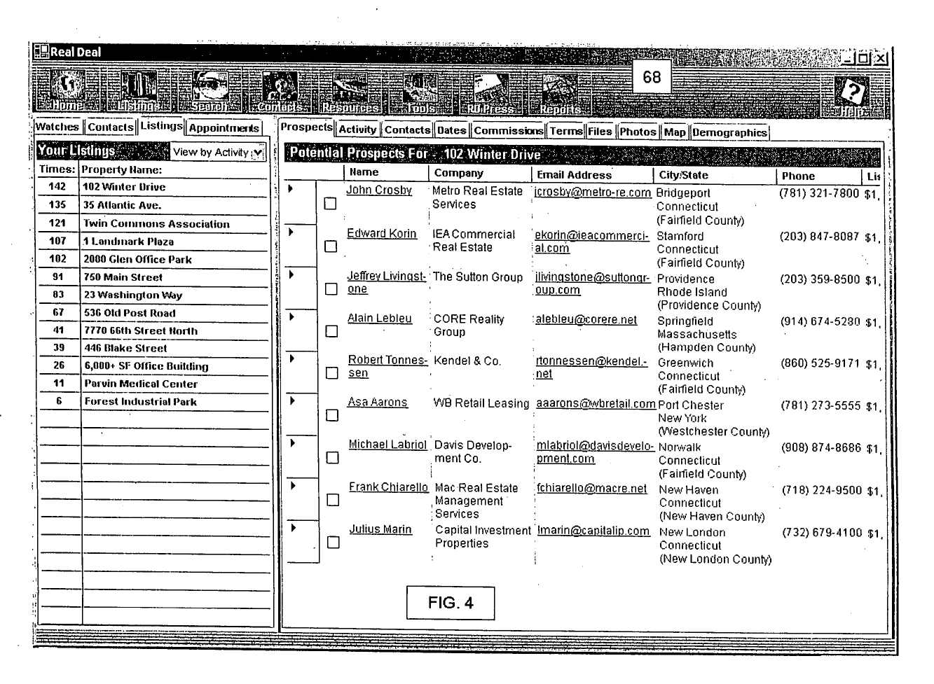

Still referring to FIG. 2, the listing tool module 68 is illustrated. The listing tool module 68 is configured to list all of the commercial real estate properties the system user has loaded into the system 10 for the purpose of selling or leasing to others as Users Property List 90. The listing tool module 68 includes the capacity to arrange the Users Property List 90 by various categories. The categories include type, expiration date and/or activity. The listing tool module 68 includes lookup fields associated with various aspects of the commercial real estate property. The lookup fields include a view potential prospects section 92, a view property activity section 94, view property terms/special terms section 96, matched listings (or matched prospects) section 98, listing dates section 100, commission rate section 102, an attached files section 104, and a photos section 106. The lookup fields can be accessed through a set of tabs in the listing tool module 18. Reference FIG. 4 for an exemplary screen-shot of a portion of the listing tool module 68.

The view potential prospects section 92 includes a display of all the people that have tracked the listing. The view potential prospects section 92 includes the capability to reveal information about the people that have tracked the listing. The information can include the persons name, company name, telephone and cell phone numbers, email address, and the like. The view potential prospects section 92 includes the function to add the information about people to a client list or a contact list. The addition can be performed using buttons in exemplary embodiments. The view potential prospects section 92 can be identified as a tab on the listing tool module 68.

The view property activity section 94 of the listing tool module 68 is configured to display counts of how the listing was viewed. The listing can be viewed as a result of a preview, an email alert, an email sent to a prospect, and the like. The view property activity section 94 is also configured to indicate how many times the listing was viewed in the particular fashion, such as a preview, an email alert, or an email sent to a prospect. The view property activity section 94 can include the capacity to provide the system user with a choice of the historical duration used to determine the viewing total for the real estate property. In an exemplary embodiment, the choice can be provided as a list.

The view property terms/special terms section 96 of the listing tool module 68 is configured to display special terms associated with the property. The special terms can include condominium association rules, landlord conditions of use, covenants, and the like. The special terms can include items that a system user desires to be written down as associated with the property. In an exemplary embodiment, buttons can be used to add and remove the special terms.

The contacts section 98 of the listing tool module 68 is configured to facilitate the system user to add all the contacts associated with a given property and sort them by name and contact type. An example for this novel section is that the contact associated with a property is the broker. Thus, the matched broker can be associated with the property. The relationship of the contact person can be used as the contact type. Contact types can include the landlord of the property, tenant, broker, buyer, seller, and the like.

The listing dates section 100 of the listing tool module 68 is configured to display the listing date of the property and the expiration date of the contract between the property owner and the broker. The listing dates section 100 is also configured to create an alert based on a calendar date of interest, such as the expiration date of the contract. The alert can be activated up to three times in a preferred embodiment. The alert can be sequenced to a variety of times, such as one day before the expiration date of the contract, one week, one month, and the like. In a preferred embodiment, the listing dates section 100 can employ a button control that transfers the system user to the appointments module 64.

The commission rate section 102 of the listing tool module 68 is configured to receive a list of commission rates for a property entered by a system user. The commission rate section 102 includes a listing of the percentage and the years to facilitate calculation of the actual commission figures by the system user. A calculator can be provided in the commission rate section 102 to calculate the rates. In a preferred embodiment, the buttons are employed to add and remove the rate information from the display.

The attached files section 104 of the listing tool module 68 is configured to facilitate the addition of files to the property listing. The files added can be considered pertinent to the property listing. The files can include a saved copy of a lease agreement, a marketing package, and other documents that a system user desires to monitor. The attached files section 104 provides the capacity to list the names of the files as well as the file type with associated icons. The list can be configured in a column labeled “type” in a preferred embodiment. The capability to add and remove files can be included with the attached files section 104. In an exemplary embodiment, a button can be included for adding and removing the files.

The photos section 106 of the listing tool module 68 is configured to attach photographs to the listing. The photo section 106 can include adding up to four photographs per property in a preferred embodiment. The photographs can include different views of the property, such as front view, rear view, interior view, and aerial view. Potential purchasers and prospects can utilize the photographs.

The map section 108 of the listing tool module 68 is configured to provide various maps of the listings address and surrounding area. In an exemplary embodiment, an aerial map can be provided.

The demographics section 110 of the listing tool module 68 is configured to include a database of real estate specific demographic statistics organized by postal zip codes, e.g., a 1, 3, 5 Mile Report.

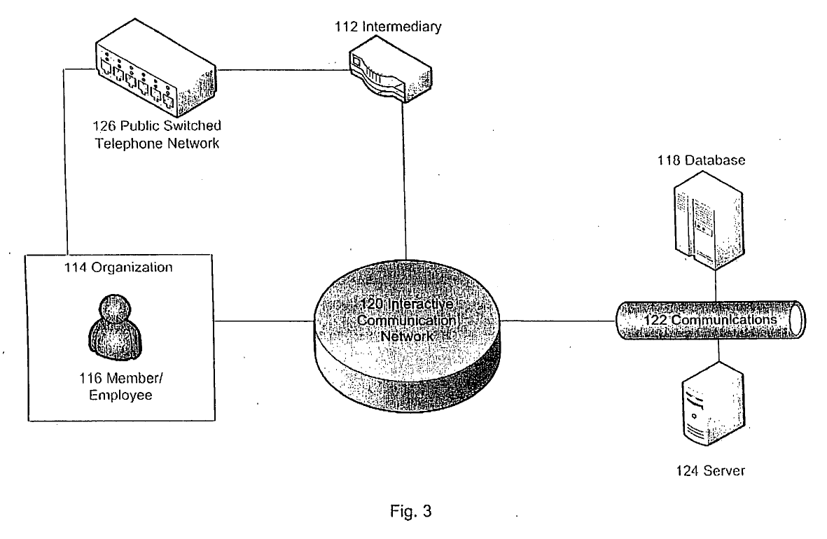

In an exemplary embodiment as shown in FIG. 3, an intermediary 112 provides real estate property services to organizations 114 for property listing data ordered by members 116 of the organization 112. The intermediary 110 provides, maintains, and monitors a computerized searchable database 118 of real estate property with associated listings. Members 116 of an organization 114 are allowed to individually access the database 118 via an interactive communication network 120 (e.g., a global communication network such as the Internet and the like). The database 118 is in communication with the interactive communication network 120 via communications software 122 and server 124. The members 116 are able to select real estate listings from the database 118. The members 116 communicate membership information (e.g., a client account number, organization account number, and/or employee number) to the intermediary 112, which membership information is stored at the intermediary 112. Although the members 116 are shown in FIG. 3 as being physically located at the office of the organization 114, the members may also access the database 118 from other locations (e.g., off site meeting or at home).

The property listings selected by the members 116 are communicated from the intermediary 112 to the members 116 (e.g., via the interactive communication network 120, via telephone or facsimile over a public switched telephone network 126, or via any other communication scheme now or hereafter available). The interactive communication network 120 may be a global communications network such as the Internet, a localized or regional communications network, or the like. In a further embodiment of the invention, the organization 114 is a brokerage firm and the members 116 are system users, such as brokers of the brokerage firm.

In another embodiment of the invention, the searchable database 118 is provided in the form of a searchable web site. The web site may include at least one web page associated with each user/member in the database, which web page displays at least one of the property type, property category, property location, and the like.

While embodiments and applications of this disclosure have been shown and described, it would be apparent to those skilled in the art that many more modifications than mentioned above are possible without departing from the inventive concepts herein. The disclosure, therefore, is not to be restricted except in the spirit of the appended claims.

What is claimed is:

1. A computerized system for managing commercial real estate properties comprising:
a core database including a property listing database and a member listing database;
a data module coupled to said core database, wherein said data module provides commercial real estate data to said core database; and
at least one working module in operative communication with said core database, wherein said at least one working module is configured to provide property specific data on a periodic basis responsive to system user criteria.

2. The system of claim 1, further comprising:
a contact manager coupled to said core database, said contact manager including a listing of contact information.

3. The system of claim 1, wherein said data module comprises one of a system users module, a mapping source module, and a demographics module.

4. The system of claim 1, wherein said at least one working module includes a first working module and a second working module in operative communication with said core database, said first working module and said second working module including at least one of a preview property module, a search property module, an add a listing module, a management tools module, a resources module and a press module.

5. The system of claim 4, wherein said first working module is configured to operate using a web based operating structure.

6. The system of claim 4, wherein said second working module is configured to operate using a local graphical user interface-based operating structure.

7. The system of claim 4, wherein said first working module includes a tools module comprising an appointments module, a prospect tool module and a listing tool module.

8. The system of claim 1 wherein said at least one working module is configured for said system user to access said property specific data responsive to said system user defined criteria upon entry into said working module.

9. The system of claim 1 wherein said at least one working module comprises a plurality of working modules.

10. A computerized method for managing commercial real estate properties comprising:
referencing a core database, said core database including a property listing database and a member listing database;
executing commands through at least one working module in operative communication with said core database, said commands enabling a system user to access property specific data responsive to system user defined criteria; and
reading data files from a data source module, said data source module including a system user module, a mapping source module and a demographic module, wherein said data source module contains said property specific data in said data files.

11. The method of claim 10 wherein said at least one working module includes at least one of a webpage tool module and a local graphical user interface (GUI) module configured to execute at least one of a preview property module, a search property module, a listing module, a resources module, a press module and a management tools module.

12. The method of claim 10 comprising:
providing a contact manager module including a database of contact entries imported from said system user.

13. The method of claim 10 wherein said property listing database:
receives said property-specific data from said system user;
cross references a location of a property related with said property-specific data with said mapping source and said demographic database; and
compiles a complete property listing.

14. The method of claim 10 wherein:
said member listing database provides user information and user preferences.

15. The method of claim 11 wherein:
said management tools module comprises a property watch module, an appointments module, a prospect tool module and a listing tool module.

16. The method of claim 15 wherein:
said appointments module lists system user entered events and tracks said system user entered events responsive to system user entry.

17. The method of claim 15 wherein:
said prospect tool module includes a property watch module adapted to filter property information responsive to predetermined system user preferences based on a type of property, saves said predetermined system user preferences, recognizes a plurality of system user preferences for access; and
said prospect tool module includes a buyers and tenants module comprising a list of contacts recorded by a user.

18. The method of claim 15 wherein said listing tool module includes:
a list of properties having associated attributes a user has loaded into said management tools module,
said list of properties viewable based on a type of property, a listing and
an expiration date related with a property from said list of properties, and
an activity related to said property.

19. The method of claim 18 wherein:
said associated attributes include at least one of a potential prospects list, a property activity list, a special terms list, a contacts list, a matched prospects list, a listing date list, a commission rate list, a special terms list, an attachment file, a photo list, a mapping module and a demographics module.

20. A system for providing real estate services to system users comprising:
an intermediary,
at least one computer having access to an interactive computer network;
a searchable database consisting of multiple modules with associated real estate information maintained and monitored by the intermediary; and
a server provided by the intermediary in communication with the computer and the database; wherein:
system users can access the searchable database with associated working modules via the interactive communication network through the computer;
the system users can select a property listing from the database;
the system users can select sections within the working modules to obtain predetermined preferences about the property; and
the working modules generate a property listing consistent with the predetermined preferences about the property.

21. The system of claim 20 comprising:
a web browser running at the computer;
a web server at the intermediary; and
at least one web page associated with each searchable database.

22. The system of claim 20 wherein said system users are members of an organization.

23. The system of claim 22 wherein said members include at least one of a commercial real estate professional and a commercial real estate practitioner.

24. The system of claim 22 wherein said organization includes at least one of brokerage firms, private and public commercial real estate investment companies and individual buyers and tenants.

25. The system of claim 20 wherein the working modules generate a property listing consistent with the predetermined preferences about the property upon entry into the system.
